(19) United States
(12) Patent Application Publication
(10) Pub. No.: US 2008/0145808 A1
(43) Pub. Date: Jun. 19, 2008

(54) Partial acyl glyceride based biowaxes, biocandles prepared therefrom and their preparation

(75) Inventor: Yi-Fa Lee, Taipei Hsien (TW)

Correspondence Address: BROMBERG & SUNSTEIN LLP, 125 SUMMER STREET, BOSTON, MA, 02110-1618, US

(73) Assignee: Chant Oil Co., Ltd., Taipei Hsien (TW)

(21) Appl. No.: 11/640,731

(22) Filed: Dec. 18, 2006

(51) Int. Cl. C11C 5/00

(52) U.S. Cl. 431/288; 44/275

(57) ABSTRACT

The present invention relates to a biowax comprising a partial acyl glyceride selected from the group consisting of a monoacylglyceride, a diacylglyceride and the combination thereof. The present invention also relates to a biocandle comprising a biowax and a wick, and to a method of producing the same.

### FIELD OF THE INVENTION

The present invention relates to a biowax comprising partial acyl glycerides (PAG). The present invention also relates to biocandles formed from said biowax, and to methods for the production of the same.

### BACKGROUND OF THE INVENTION

Many types of candles have already been developed on the market. Conventionally, candles are made by paraffin and/or natural waxes. Some typical candles prepared by conventional methods can be formed as container candles, votive candles, pillar candles, taper candles, tea-light candles and hurricane candles.

For a long time, it has been known that biowaxes, such as beeswax (myricyl palmitate) and spermaceti wax (cetyl palmitate), etc., can be used as natural waxes for the preparation of candles. Later, fossil waxes, such as paraffin, etc., are used as raw materials of candle waxes for the preparation of candles, in parallel with the development of the petroleum refining industry.

Today, paraffin-based waxes are major raw materials for the production of candles. The paraffin is produced from the residue left after refinement of fossil oils. It was found that paraffin can be completely burned, but it typically emits a smoke and produces an unpleasant odor when burning.

Palm stearin is a byproduct from palm oil refinery industry. The yield of palm stearin every year is huge and the price thereof is more inexpensive than paraffin. It has attempted to apply palm stearin as an ingredient of candle wax. However, due to the lower melting point property of the palm stearin, the compounding percentage in candle wax is limited and difficultly controlled. Even though the palm stearin may be hydrogenated to be one having a higher melting point, candles made therefrom are brittle and lack malleability. Thus, the application of palm stearin as an ingredient of candle wax is still limited.

To provide the candles having clean burning characteristics, extensive researches on candle waxes having low paraffin content have been conducted. For example, U.S. Pat. Nos. 6,503,285; 6,645,261; 6,770,104; 6,773,469; 6,797,020; and 6,824,572 disclose triacylglycerol based candle waxes, particularly those derived from various animal and/or plant sources, such as vegetable oil-source.

However, candle waxes formulated from vegetable oil-based materials often result in a variety of problems. It was found that vegetable oil-based candles have many disadvantages, such as cracking, air pocket formation and a natural product odor associated with soybean materials, as compared with paraffin-based candles. In addition, the soybean-based waxes have performance problems relating to optimum flame size, effective wax and wick performance matching for an even burn, maximum burning time, product color integration and/or product shelf life. Hence, to have the aesthetic and functional product surface and quality required by consumers, it is necessary to develop new substitutive vegetable oil-based waxes.

Accordingly, there exists a need to develop substitutive wax materials. Said substitutive wax materials have clean burning property when being used for forming candles. It is also desirable for such materials to be biodegradable and to be derived from renewable raw materials. It is particularly desirable for the candle base wax materials to have certain physical characteristics, such as melting point, hardness and/or malleability, etc., that permit the materials to be readily formed into candles having a pleasing appearance and/or feel to the touch, as well as having desirable olfactory properties.

Further, the Kyoto Protocol establishes agreements relating to environmental (i.e., “green”) issues in every aspect on the earth and its objective is “the stabilization of greenhouse gas concentrations in the atmosphere at a level that would prevent dangerous anthtopogenic interference with the climate system.” As fossil fuel resources are scarce and the oil prices are soaring up, biomass fuels play a vital role on renewable energy supply chain. In the fast developing biodiesel supply chain, the oversupply of glycerol becomes an urgent problem to be solved.

### SUMMARY OF THE INVENTION

In accordance with one aspect of the invention there is provided partial acyl glyceride (PAG)-based biowaxes. Such PAG-based biowaxes can be produced from the oversupply of glycerol in the biodiesel supply chain, which can help solve the problem of excess production of glycerol in the biodiesel supply chain. Embodiments of the invention that consume the glycerol to produce PAG-based biowax and use the biowax in the formation of “green” candles can facilitate the healthy development of the Carbon Cycle on Earth, specifically by allowing fossil energy to be redirected to where it is most valuable and feasible (e.g., agricultural energy policy).

In accordance with another aspect of the invention, the PAG-based biowax may be useful as candle wax. A PAG-based biocandle has burning characteristic comparable to commercial candles made from paraffin wax in terms of flame length and is free of unpleasant odor. It has superior characteristics than paraffin wax which include low soot emission and high additives compatibility. It would be advantageous to use PAG-based biowax to replace paraffin wax.

In accordance with another aspect of the invention there is provided a biocandle comprising a biowax and a wick, wherein the biowax comprises partial acyl glycerides. Further, the candles may also be formed from PAG-based biowaxes containing paraffin and/or stearin as additional ingredients. The candles prepared therefrom generally exhibit uniform texture, translucent and fine grain crystalline structure. The candles are generally clean burning and emit very little soot. Due to the combination of low soot emission and biodegradability, the production of candles from renewable raw materials makes the present candles a particularly environmentally friendly product.

In accordance with yet another aspect of the invention there is provided a method for preparing biocandles involving heating PAG-based biowax to a molten state; introducing the molten biowax into a mold, wherein the mold includes a wick disposed therein; cooling the molten biowax in the mold to solidify the biowax; and removing the solidified biowax from the mold, wherein the biowax comprises a partial acyl glyceride selected from the group consisting of monoacylglycerides, diacylglycerides, and the combination thereof.

In accordance with still another aspect of the invention there is provided a method of producing a biocandle involving heating PAG-based biowax to a molten state; spray cooling the molten biowax to form 0.5 to 1.2 mm beads; and compressing the biowax beads into a mold to form a candle.

With methods of the present invention, various types of biocandles, such as container candles, candle beads, etc. may be formed.

### BRIEF DESCRIPTION OF DRAWINGS

The foregoing and advantages of the invention will be appreciated more fully from the following further description thereof with reference to the accompanying drawings wherein:

FIG. 1 shows the gas chromatographic analysis result of GMP.

FIG. 2 shows the gas chromatographic analysis result of partial acyl glycerides of Example 8 (defined as GMS_{IV=1.0}).

FIG. 3 shows the gas chromatographic analysis result of partial acyl glycerides (defined as GMS_{IV=15}).

FIG. 4 shows the gas chromatographic analysis result of partial acyl glycerides of Example 11 (defined as GMS_{IV=20})

FIG. 5 shows the gas chromatographic analysis result of partial acyl glycerides of Example 12 (defined as GMS_{IV=30}).

### DETAILED DESCRIPTION OF SPECIFIC EMBODIMENTS

In embodiments of the present invention, a biowax comprises partial acyl glycerides (PAG). In specific embodiments, the biowax may comprise about 20 wt. % to 100 wt. %, and particularly 30 wt. % to 100 wt. %, of PAG, based on the total weight of the biowax.

As used in this description and the accompanying claims, the term “biowax” shall refer to waxes produced from the raw materials derived from the biodiesel supply chain unless the context otherwise requires. The term “partial acyl glyceride” shall refer to a glyceride selected from the group consisting of a monoacylglyceride (MAG), a diacylglyceride (DAG), or a combination thereof, unless the context otherwise requires. The partial acyl glyceride may be obtained by the esterification of glycerol molecules with one or two medium or long fatty acids chain. The term “medium chain fatty acid” shall refer to a saturated or unsaturated fatty acid having 6 to 10 carbons, or a mixture thereof, unless the context otherwise requires. As used herein, the term “long chain fatty acid” shall refer to a saturated or unsaturated fatty acid having 14 to 24 carbons, or a mixture thereof, unless the context otherwise requires. The acyl group may have straight chains of C16, C18, C18:1, C18:2. In various embodiments of the present invention, the partial acyl glyceride can be used alone, or in combination with triacyglycerides and/or other ingredients. As used herein, the term “biocandle” shall refer to candles produced from biowaxes unless the context otherwise requires.

In certain embodiments of the present invention, the biowax may further comprise triacylglyceride (TAG), stearin, or paraffin or a combination thereof as an additional ingredient. In one exemplary embodiment of the present invention, the biowax comprises a monoacylglyceride (MAG), a diacylglyceride (DAG) and a triacylglyceride (TAG). The monoacylglyceride may be used in an amount of about 10 to 75 wt. %, and particularly in an amount of about 40 to 70 wt. %, based on the weight of the biowax. The diacylglyceride (DAG) may be used in amount of about 10 to 50 wt. %, and particularly in an amount of about 10 to 35 wt. %, based on the weight of the biowax. The triacylglyceride (TAG) may be optionally used in an amount of about 5 to 50 wt. %, and particularly in an amount of 10 to 40 wt. %, based on the weight of the biowax.

In certain embodiments of the present invention, the biowax may optionally include minor amounts of other additives to modify the properties of the waxy materials. Examples of the additives that may be incorporated into the biowax include colorants, fragrances (e.g., fragrance oils), antioxidants, UV light absorber and migration inhibitors, and the like. It is desirable for the biowax to be blended with natural colorants to provide an even, solid color distribution.

Biowax has a melting point of about 40 to 62° C. In one embodiment, the biowax has an Iodine Value of about 0.2 to 35.

In certain embodiments of the present invention, the biowax can be formed into a desired shape. According to one exemplary embodiment, the biowax may be formed into powdered or ground particles. For example, the biowax can be formed into beads, e.g. by heating the biowax to a molten state and then spray cooling the molten biowax, or by means of a bead-manufacturing device commercially available from Chant Oil Co., Ltd. (Taiwan, R.O.C.). In exemplary embodiments of the present invention, the biowax may be shaped into beads having a diameter of about 0.5 to 1.2 mm.

Biowaxes of the type described above are suitable as raw materials for the manufacture of biocandles.

Thus, embodiments of the present invention also include a biocandle comprising a biowax and a wick, wherein the biowax comprises partial acyl glycerides (PAG). Such a biocandle is typically solid, firm but not brittle, generally somewhat malleable, with no free oil visible. In certain embodiments of the present invention, the biocandles may be prepared by means of melt-processing to form the desired shape of candles, such as pillar candles, tea light candles, etc.

In order to more fully benefit from the environmentally-safe aspect of said PAG-based biowax, it is desirable to use a wick that does not have a metal core, such as a lead or zinc core. One example of a suitable wick material is a braided cotton wick. The wick may include standard wicks employed with other waxes (e.g., paraffin and/or beeswax).

Biocandles of the type described above may be prepared by heating the PAG-based biowax to a molten state; introducing the molten biowax into a mold, wherein the mold includes a wick disposed therein; cooling the molten biowax in the mold in order to solidify the biowax; and then removing the solidified biowax from the mold.

Alternatively, biocandles of the type described above may be prepared by heating the PAG-based biowax to a molten state, spray cooling the biowax to form 0.5 to 1.2 mm beads and compressing the biowax beads into a mold to form as candles.

Biocandles of the type described above may be prepared in other ways and the present invention is not limited to any particular way of preparing such biocandles.

For preparation of biocandles, it is desirable for the colorants, if present, to be dissolved in the PAG-based biowax in order to prevent insoluble particles from blocking the biowax flow in the wick. Generally, the blocked biowax flow results in a poor candle burn. Further, the color of the biowax may also affect the dying performance. Most fragrances can be applied to the biowax to improve the performance of the resulting biocandles, such as stability, reactivity, color, etc.

Biocandles of the type described above are generally clean burning and emit very little soot.

It should be noted that all numbers expressing quantities of ingredients, properties, etc. in the description and claims are to be understood as being modified in all instances by the term “about”, and all parts and percentages referred to in this description and claims are by weight, unless otherwise specified.

A number of exemplary embodiments are described below. These examples are not intended in any way to limit the scope of the invention. Notwithstanding that the numerical ranges and parameters setting forth the broad scope are approximations, the numerical values set forth in the specific example are reported as precisely as possible. Any numerical value, however, inherently contains certain errors necessarily resulting from the standard deviation found in its respective testing measurements.

### EXAMPLES

### A. Gas Chromatographic Analysis of PAG

GC Model: YOUNGLIN ACME 6000M GC

GC Conditions:
1. Column: QUADREX fused silica capillary column;
   007-65HT-25W-0.1F, 0.32 mmID
2. Detector: FID
3. Carrier Gas: Nitrogen
4. Oven Temperature:
   1) 80° C. (Hold 1 min), and to 240° C. in a rate of 20° C./min;
   2) 240° C., and to 360° C. in a rate of 4° C./min;
   3) 360° C. (Hold 11 min)
5. Injector Temperature: 280° C.
6. Detector Temperature: 360° C.
7. Determination Range: 6×10³ mV

Preparation of Samples:
Homogeneously mixing 0.2 gm of sample with 5 cc chloroform.

Analysis Conditions:
1. Sample Content: 0.2 μl
2. Analysis Time: 50 mins

### B. Components for the Preparation of Waxes

Component 1: Paraffin wax, supplied by Taiwan Wax Co., Ltd., has the physical properties listed on Table 1.

TABLE 1

| Physical Property | Test Method | Value |
|---|---|---|
| M.P., ° C. | ASTM D87 | 59.8 |
| Needle Penetration at 25° C., mm | ASTM D1321 | 15.5 |
| Kinetic Viscosity at 100° C., cps | ASTM D445 | 4.382 |
| Oil Content, wt. % | ASTM D721 | 0.116 |
| Color | ASTM D156 | 30 |
| Carbon Distribution | ASTM D5442 | C₂₀~C₄₆ |
| <C₂₆ | | 16.48% |
| C_{26–29} | | 23.78% |
| C_{29–32} | | 23.05% |
| C_{32–44} | | 36.69% |
| >C₄₄ | | nil |
| n-Paraffin | | 51.05% |

Component 2: Fatty acid S1801, supplied by P.T. MUSIM MAS., has the physical properties listed on Table 2.

TABLE 2

| Physical Property | Test Method | Value |
|---|---|---|
| Acid Value, mg KOH/g | ASTM D 1980–87 | 210.2 |
| Saponification Value, mg KOH/g | ASTM D1962–85 | 211.4 |
| Iodine Value, g Iodine/100 g | ASTM D 1959–97 | 0.13 |
| M.P., ° C. | ASTM D 1982–85 | 55.4 |
| Fatty Acid Carbon Chain Composition, % | ASTM D 1983–90 | |
| C12 + 14 | | 0.4 |
| C16 | | 57.67 |
| C18 | | 41.3 |
| Others | | 0.5 |

Component 3: Fatty acid 1698, supplied by P.T. MUSIM MAS., has the physical properties listed on Table 3.

TABLE 3

| | Value |
|---|---|
| Physical Property | |
| Acid Value, mg KOH/g | 218.5 |
| Saponification Value, mg KOH/g | 220 |
| Iodine Value, g Iodine/100 g | 0.1 |
| M.P., ° C. | 62.0 |
| Fatty Acid Carbon Chain Composition, % | |
| C12 + 14 | 0.3 |
| C16 | 98.6 |
| C18 | 1.1 |
| Others | 0.5 |

Component 4: Two types of RBD Palm Stearin supplied by P.T. MUSIM MAS. having the physical properties listed Table 4.

TABLE 4

| | Type 1 | Type 2 |
|---|---|---|
| Physical Property | | |
| Free Fatty Acid, % | 0.057 | 0.01 |
| Iodine Value, g Iodine/100 g | 20.4 | 33.3 |
| M.P., ° C. | 56.5 | 51 |
| Fatty Acid Carbon Chain Composition, % | | |
| C16 | 72.00 | 59.8 |
| C18 | 5.10 | 3.67 |
| C18:1 | 16.22 | 29.7 |
| C18:2 | 3.67 | 5.22 |

Component 5: Hardened Fat FO81, made by hydrogenation of RBD palm stearin (Type 2, Component 4) at a temperature of from 170 to 200° C. and at a pressure of 3 kg in the presence of Ni catalyst (0.2%) for 4 hours, has the physical properties listed on Table 5.

TABLE 5

| | Value |
|---|---|
| Physical Property | |
| Acid Value, mg KOH/g | 1.2 |
| Saponification Value, mg KOH/g | 196.8 |
| Iodine Value, g Iodine/100 g | 0.4 |
| M.P., ° C. | 57 |
| Color Gardner | 1.3 |
| Fatty Acid Carbon Chain Composition, % | |
| C16 | 59.8 |
| C18 | 38.6 |

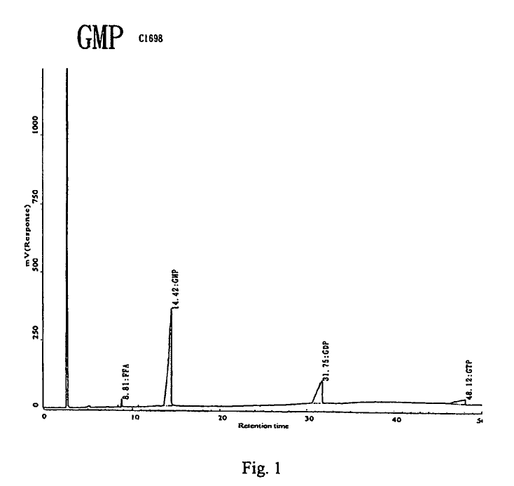

Component 6: Partial Acyl Glyceride defined as GMP, made by the reaction of 200 gm of Fatty Acid 1698 (Component 3) with 72 gm of glycerol at 250° C. for 5 hours, has the physical properties listed on Table 6a and GC analysis result and data respectively shown in FIG. 1 and Table 6b.

TABLE 6a

| Physical Property | Value |
|---|---|
| Free Fatty Acid, % | 1.2 |
| M.P., ° C. | 56 |
| MAG, % | 64.0 |
| DAG, % | 25.5 |
| TAG, % | 9.3 |

MAG: Monoacylglyceride
DAG: Diacylglyceride
TAG: Triacylglyceride

TABLE 6b

| | | | | Percentage |
|---|---|---|---|---|
| Peak No. | Component | Retention Time (second) | Area | (%) |
| 1 | FFA | 8.813 | 146.88 | 1.20 |
| 2 | GMP | 14.424 | 7845.39 | 63.98 |
| 3 | GDP | 31.754 | 3132.86 | 25.54 |
| 4 | GTP | 48.118 | 1137.85 | 9.28 |

FFA: Free Fatty Acid
GMP: Glycerol Monopalmitate
GDP: Glycerol Dipalmitate
GTP: Glycerol Tripalmitate

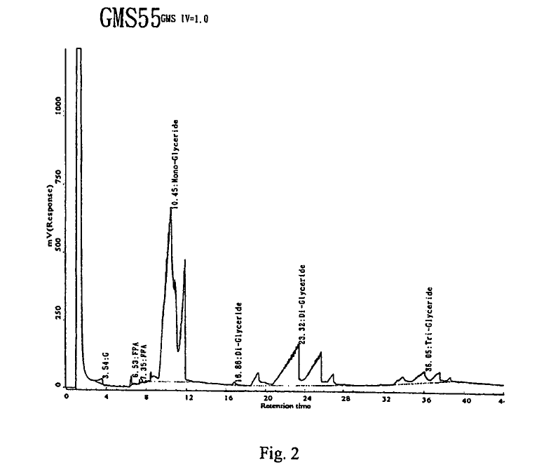

Component 7: Partial Acyl Glyceride defined as GMS_{IV=1.0}, made by the reaction of 200 gm of Fatty Acid S1801 (Component 2) with 72 gm of glycerol at 250° C. for 5 hours, has the physical properties listed on Table 7a and GC analysis result and data respectively shown in FIG. 2 and Table 7b.

TABLE 7a

| Physical Property | Value |
|---|---|
| Acid Value, mg KOH/g | 0.4 |
| Iodine Value, mg KOH/g | 0.2 |
| Color, APHA | 140 |
| M.P., ° C. | 56 |
| MAG, % | 62.6 |
| DAG, % | 28.8 |
| TAG, % | 7.6 |

TABLE 7b

| | | Retention Time | | Percentage |
|---|---|---|---|---|
| Peak No. | Component | (second) | Area | (%) |
| 1 | G | 3.539 | 519.91 | 0.65 |
| 2 | FFA | 6.525 | 233.16 | 0.29 |
| 3 | FFA | 7.350 | 46.61 | 0.06 |
| 4 | Mono-Glyceride | 10.453 | 48623.36 | 60.90 |
| 5 | Di-Glyceride | 16.861 | 215.56 | 0.27 |
| 6 | Di-glyceride | 23.320 | 24237.86 | 30.36 |
| 7 | Tri-Glyceride | 36.047 | 5964.83 | 7.47 |

G: Glycerol

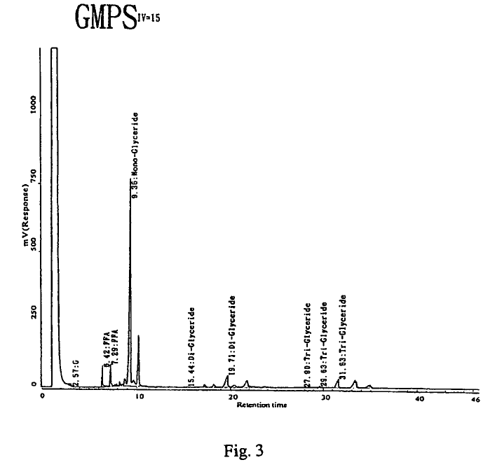

Component 8: Partial Acyl Glyceride defined as GMS_{IV=15}, made by a 200 gm of mixture of equal amount of FO81 (Component 5) and RBD palm stearin (Type 2, Component 4) with 40 gm of glycerol at 250° C. for 8 hours, has the physical properties listed on Table 8a and GC analysis result and data respectively shown in FIG. 3 and Table 8b.

TABLE 8a

| Physical Property | Value |
|---|---|
| M.P., ° C. | 46 |
| MAG, % | 68.35 |
| DAG, % | 15.69 |
| TAG, % | 11.72 |

TABLE 8b

| | | Retention Time | | |
|---|---|---|---|---|
| Peak No. | Component | (second) | Area | Percentage (%) |
| 1 | G | 2.572 | 83.89 | 0.62 |
| 2 | FFA | 6.424 | 487.76 | 3.61 |
| 3 | FFA | 7.287 | 558.61 | 4.14 |
| 4 | Mono-Glyceride | 9.360 | 8665.79 | 64.21 |
| 5 | Di-Glyceride | 15.445 | 10.99 | 0.08 |
| 6 | Di-glyceride | 19.710 | 2106.60 | 15.61 |
| 7 | Tri-Glyceride | 27.898 | 6.40 | 0.05 |
| 8 | Tri-Glyceride | 29.627 | 42.31 | 0.31 |
| 9 | Tri-Glyceride | 31.626 | 1532.99 | 11.36 |

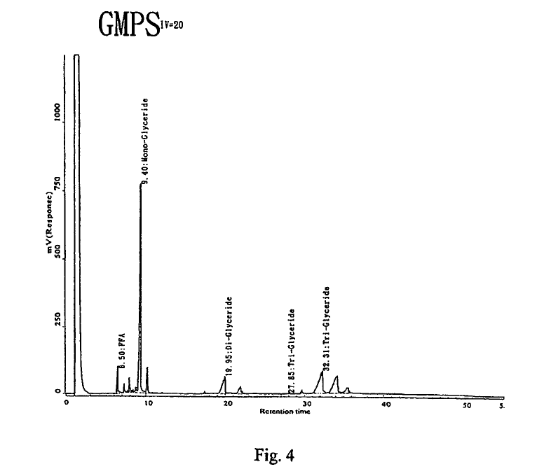

Component 9: Partial Acyl Glyceride defined as GMS_{IV=20}, made by the reaction of 200 gm of RBD palm stearin (Type 1, Component 4) with 40 gm of glycerol at 250° C. for 8 hours, has the physical properties listed on Table 9a and GC analysis result and data respectively shown in FIG. 4 and Table 9b.

TABLE 9a

| Physical Property | Value |
|---|---|
| Color | 1.4 |
| M.P., ° C. | 46 |
| MAG, % | 49.6 |
| DAG, % | 11.1 |
| TAG, % | 33.1 |

TABLE 9b

| | | Retention Time | | |
|---|---|---|---|---|
| Peak No. | Component | (second) | Area | Percentage (%) |
| 1 | FFA | 6.499 | 989.15 | 5.25 |
| 2 | Mono-Glyceride | 9.405 | 8776.13 | 46.60 |
| 3 | Di-Glyceride | 19.948 | 2471.18 | 13.12 |
| 4 | Tri-Glyceride | 27.846 | 16.10 | 0.09 |
| 5 | Tri-Glyceride | 32.311 | 6582.08 | 34.95 |

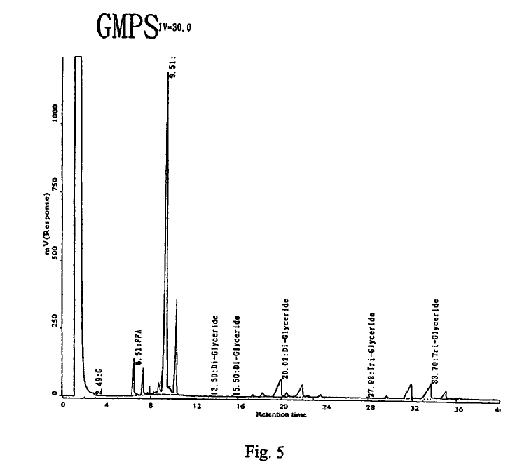

Component 10: Partial Acyl Glyceride designed as GMS_{IV=30}, made by the reaction of 200 gm of RBD palm stearin (Type 2, from Component 4) with 40 gm of glycerol at 250° C. for 8 hours, has the physical properties listed on Table 10a and GC analysis result and data respectively shown in FIG. 5 and Table 10b.

TABLE 10a

| Physical Property | Value |
|---|---|
| M.P., ° C. | 42 |
| MAG, % | 66.2 |
| DAG, % | 13.4 |
| TAG, % | 13.3 |

TABLE 10b

| | | Retention Time | | Percentage |
|---|---|---|---|---|
| Peak No. | Component | (second) | Area | (%) |
| 1 | G | 2.489 | 49.89 | 0.18 |
| 2 | FFA | 6.511 | 1933.86 | 6.93 |
| 3 | Mono-Glyceride | 9.507 | 18463.30 | 66.20 |
| 4 | Di-Glyceride | 13.502 | 14.22 | 0.05 |
| 5 | Di-Glyceride | 15.504 | 20.38 | 0.07 |
| 6 | Di-Glyceride | 20.023 | 3715.59 | 13.32 |
| 7 | Tri-Glyceride | 27.924 | 18.28 | 0.07 |
| 8 | Tri-glyceride | 33.699 | 3674.74 | 13.18 |

### C. Preparation of Container Candle (as Listed in Table 11) to be Tested:

Various components were mixed in an equal weight amount and molten. The molten waxes were poured into an aluminum cup having 15 mm height×37.5 mm diameter with a 23 mm length of braided cotton wick disposed in the middle of the cup. The resulting candles were cooled and solidified for the burning test.

### Examples 1 to 13

The container candles were prepared according to the components and contents listed on Table 11.

### D. Burning Test

The burning performances of biocandles prepared from partial acyl glyceride (PAG) based biowaxes were carried out by following the steps below:
1. numbering and weighing each of container candles having various amounts of components;
2. placing the container candle separated by a distance of 100 mm on the experimental table;
3. placing a plaster slab 75 mm above the table, to observe the smoke emitting from the candles, when burning;
4. igniting the container candles and starting timing; measuring the flame heights of each container candles as soon as possible, when the wax is molten around each of the wick (about 5-6 minutes);
5. measuring the flame heights at an interval of one hour;
6. measuring the temperatures at the highest point of inside flame for each container candle after 60 minutes;
7. weighing each container candle after one of them burned out; and then calculating its burning rates of each container candle.

The burning test results of the container candles are shown on Table 11.

TABLE 11

| | Example No. | | | | | | | | | | | | |
|---|---|---|---|---|---|---|---|---|---|---|---|---|---|
| | | | | | | | | | 9 | | | | |
| | 1 | 2 | 3 | 4 | 5 | 6 | 7 | 8 | (Comparative) | 10 | 11 | 12 | 13 |
| Component 1: | 3.91 | 4.94 | 5.23 | | | | 7.78 | | 7.49 | | | | |
| Paraffin | | | | | | | | | | | | | |
| wax (weight, g) | | | | | | | | | | | | | |
| Component 2: | 3.91 | 4.94 | | 5.49 | 7.99 | | | | 7.49 | | | | |
| S1801 | | | | | | | | | | | | | |
| (weight, g) | | | | | | | | | | | | | |
| Component 5: | 3.91 | | 5.23 | 5.49 | | 7.78 | | | | | | | |
| FO81 | | | | | | | | | | | | | |
| (weight, g) | | | | | | | | | | | | | |
| Component 6: | | | | | | | | | | | | | 21.59 |
| GMP | | | | | | | | | | | | | |
| (weight, g) | | | | | | | | | | | | | |
| Component 7: | 3.91 | 4.94 | 5.23 | 5.49 | 7.99 | 7.78 | 7.78 | 15.32 | | | | | |
| GMS_{IV=1.0} | | | | | | | | | | | | | |
| (weight, g) | | | | | | | | | | | | | |
| Component 8: | | | | | | | | | | 23.26 | | | |
| GMS_{IV=15} | | | | | | | | | | | | | |
| (weight, g) | | | | | | | | | | | | | |
| Component 9: | | | | | | | | | | | 22.87 | | |
| GMS_{IV=20} | | | | | | | | | | | | | |
| (weight, g) | | | | | | | | | | | | | |
| Component 10: | | | | | | | | | | | | 22.04 | |
| GMS_{IV=30} | | | | | | | | | | | | | |
| (weight, g) | | | | | | | | | | | | | |

Properties

| | | | | | | | | | | | | | |
|---|---|---|---|---|---|---|---|---|---|---|---|---|---|
| MP (° C.) | 50.5 | 52 | 52 | 51.5 | 52 | 53 | 57.5 | 54 | 52 | 46 | 46 | 42 | 52 |
| Initial weight (g) | 15.64 | 14.82 | 15.69 | 16.47 | 15.98 | 15.56 | 15.56 | 15.32 | 14.98 | 23.26 | 22.87 | 22.04 | 21.59 |
| Remain | 4.77 | 3.10 | 3.64 | 6.76 | 7.37 | 5.60 | 2.78 | 3.62 | 3.88 | 14.24 | 14.00 | 15.11 | 10.60 |
| weight (g), | | | | | | | | | | | | | |
| after 132 min. | | | | | | | | | | | | | |
| Burn rate (g/hr) | 4.94 | 5.32 | 5.48 | 4.42 | 3.91 | 4.53 | 5.80 | 5.32 | 5.04 | 4.10 | 4.03 | 3.15 | 5.00 |
| Flame | 731 | 768 | 757 | 711 | 729 | 777 | 839 | 881 | 806 | 835 | 740 | 668 | 820 |
| Temperature | | | | | | | | | | | | | |
| (° C.) | | | | | | | | | | | | | |
| Flame Height | 26 | 27 | 25 | 23 | 24 | 24 | 27 | 22 | 33 | 15 | 25 | 20 | 25 |
| (mm), | | | | | | | | | | | | | |
| after 6 min. | | | | | | | | | | | | | |
| Flame Height | 26 | 26 | 26 | 22 | 15 | 25 | 30 | 22 | 28 | 18 | 18 | 10 | 18 |
| (mm), | | | | | | | | | | | | | |
| after 70 min. | | | | | | | | | | | | | |
| Flame Height | 21 | 24 | 30 | 20 | 15 | 23 | 23 | 21 | 27 | 15 | 17 | 6 | 24 |
| (mm), | | | | | | | | | | | | | |
| after 132 min. | | | | | | | | | | | | | |

As shown on Table 11, the biocandles made by the biowaxes of the present invention, together with a balanced amount of paraffin and/or stearin, exhibit excellent wax flow through wicks by visual appearance. Meanwhile, the biocandles of the present invention show steady burn rate and good appearances, such as color, fragrance and clarity, and also emit low soot when burning and good smell.

While various exemplary embodiments of the present invention are described herein, it should be noted that the present invention may be embodied in other specific forms, including various modifications and improvements, without departing from the spirit and scope of the present invention. Thus, the described embodiments are to be considered in all respects only as illustrative and not restrictive. The scope of the present invention is indicated by the appended claims, and all changes that fall within the meaning and range of equivalents are intended to be embraced therein.

What is claimed is:

1. A biowax, comprising a partial acyl glyceride selected from the group consisting of monoacylglycerides and diacylglycerides, and the combination thereof.

2. A biowax according to claim 1, wherein the partial acyl glyceride is present in an amount of 20 wt. % to 100 wt. %, based on the total weight of the biowax.

3. A biowax according to claim 1, wherein the partial acyl glyceride is present in an amount of 30 wt. % to 100 wt. %, based on the total weight of the biowax.

4. A biowax according to claim 1, further comprising triacylglycerides.

5. A biowax according to claim 4, wherein the monoacylglycerides are in an amount of about 10 to 75 wt. % and the diacylglycerides are in an amount of about 10 to 50 wt. %, and the triacylglycerides are in an amount of about 5 to 50 wt. %, based on the weight of the biowax.

6. A biowax according to claim 5, wherein the triacylglycerides are in an amount of about 10 to 40 wt. %, based on the weight of the mixture.

7. A biowax according to any of claims 1, 2, 3, 4, 5, or 6, further comprising at least one of a colorant, an antioxidant, a fragrance, an ultraviolet light absorber, and a migration inhibitor.

8. A biowax according to claim 7, which is formed into beads having a diameter of about 0.5 to 1.2 mm.

9. A biowax according to any of claims 1, 2, 3, 4, 5, or 6, which has a melting point of about 40 to 62° C.

10. A biowax according to any of claims 1, 2, 3, 4, 5, or 6, which has an Iodine Value of about 0.2 to 35.

11. A biocandle comprising:
a biowax comprising a partial acyl glyceride selected from the group consisting of monoacylglycerides and diacylglycerides, and the combination thereof; and
a wick.

12. A biocandle according to claim 11, wherein the partial acyl glyceride is present in an amount of 20 wt. % to 100 wt. %, based on the total weight of the biowax.

13. A biocandle according to claim 11, wherein the partial acyl glyceride is present in an amount of 30 wt. % to 100 wt. %, based on the total weight of the biowax.

14. A biocandle according to claim 11, further comprising triacylglycerides.

15. A biocandle according to claim 14, wherein the monoacylglycerides are in an amount of about 10 to 75 wt. % and the diacylglycerides are in an amount of about 10 to 50 wt. %, and the triacylglycerides are in an amount of about 5 to 50 wt. %, based on the weight of the biowax.

16. A biocandle according to claim 15, wherein the triacylglycerides are in an amount of about 10 to 40 wt. %, based on the weight of the mixture.

17. A method of producing a biocandle, the method comprising:
1) heating PAG-based biowax to a molten state;
2) introducing the molten biowax into a mold, wherein the mold includes a wick disposed therein;
3) cooling the molten biowax in the mold to solidify the biowax; and
4) removing the solidified biowax from the mold,
wherein the biowax comprises a partial acyl glyceride selected from the group consisting of monoacylglycerides, diacylglycerides, and the combination thereof.

18. A method of producing a biocandle, the method comprising:
1) heating PAG-based biowax to a molten state;
2) spray cooling the molten biowax to form 0.5 to 1.2 mm beads; and
3) compressing the biowax beads into a mold to form a candle.
